(19) United States
(12) Patent Application Publication
(10) Pub. No.: US 2026/0268076 A1
(43) Pub. Date: Sep. 10, 2026

(54) LARGE LANGUAGE MODEL HALLUCINATION REDUCTION

(71) Applicant: SAP SE, Walldorf (DE)

(72) Inventor: David Kunz, Wilhelmsfeld (DE)

(21) Appl. No.: 19/073,497

(22) Filed: Mar. 7, 2025

(51) Int. Cl. G06F 40/20

(52) U.S. Cl. CPC G06F 40/20

(57) ABSTRACT

In an example embodiment, hallucinations in LLMs are reduced by incorporating specific training data that includes question/answer pairs where the answer in the training data is some variation of "I cannot answer this question." This technique involves constructing questions that cannot be answered due to unknown factual knowledge or logical questions that cannot be answered due to missing information. By training the LLM with such data, the model learns to recognize when it lacks the necessary information to provide a correct answer, thereby reducing the likelihood of generating plausible-sounding but incorrect responses. The described technique enhances user trust in LLMs by minimizing the risk of decisions being made based on incorrect information.

### TECHNICAL FIELD

This document generally relates to computer systems. More specifically, this document relates to the use of large language models.

### BACKGROUND

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for training an LLM, in accordance with an example embodiment.

FIG. 2 is a block diagram illustrating a system for training an LLM, in accordance with another example embodiment.

FIG. 3 is a block diagram illustrating a system for training a first LLM, in accordance with another example embodiment.

FIG. 4 is a flow diagram illustrating a method for training a large language model (LLM), according to some examples, to reduce hallucinations in LLM outputs.

FIG. 5 is a block diagram illustrating an architecture of software, which can be installed on any one or more of the devices described above.

FIG. 6 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Large language models (LLMs) have become increasingly prevalent in various applications due to their ability to generate human-like text. However, a significant challenge with LLMs is their tendency to produce "hallucinations," where the model generates plausible-sounding but incorrect or nonsensical information. This issue arises because LLMs are trained on vast datasets to predict the next word in a sequence, which can lead to overconfidence in generating answers even when the model lacks the necessary information. Such hallucinations can mislead users, erode trust in the technology, and result in decisions based on inaccurate data.

Existing methods to mitigate hallucinations include setting thresholds for token prediction probabilities and incorporating additional knowledge into the training data. Another approach involves grounding the LLM by providing relevant information in the prompt. While these techniques offer some improvements, they often fall short in effectively reducing hallucinations across diverse contexts. As a result, there is a pressing need for more robust solutions that can enhance the reliability of LLMs and ensure that users receive accurate and trustworthy information.

In an example embodiment, hallucinations in LLMs are reduced by incorporating specific training data that includes question/answer pairs where the answer in the training data is some variation of "I cannot answer this question." This technique involves constructing questions that cannot be answered due to unknown factual knowledge or logical questions that cannot be answered due to missing information. By training the LLM with such data, the model learns to recognize when it lacks the necessary information to provide a correct answer, thereby reducing the likelihood of generating plausible-sounding but incorrect responses. The described technique enhances user trust in LLMs by minimizing the risk of decisions being made based on incorrect information.

The problem and solution can best be illustrated using a specific example. An LLM may be trained with information about the capital of every country. This information may be in the form of “The capital of France is Paris.” When presented with a country, however, that the LLM is not familiar with (or even does not exist), the LLM will still provide an answer, even if that answer is manifestly incorrect. Thus, asking the LLM a question like “What is the capital of Lululand,” the LLM is inclined to answer in an arbitrary way, such as “The capital of Lululand is Lululala.”

Thus, in order to prevent or at least reduce the chances that the LLM will answer in this way, in an example embodiment, an LLM is trained with question and answer pairs where the answer is something like “I cannot answer this question.” The questions themselves may take two different forms. The first is a question of unknown factual knowledge, specifically where the question is about a made up subject or entity. Thus, the question could be “What is the capital of Lululala?” and the answer may be “I cannot answer this question because I have no knowledge of Lululala.” This trains the LLM to indicate that it cannot answer a question and provide a reason.

The second form the questions may take is questions that cannot be logically answered since needed context is missing. An example of such a question is “Bob has three sisters, how many brothers does Bob have?” with the answer being “I cannot answer this question because of missing information.”

These types of sample questions and answers can be generated by humans or may be performed automatically using a rule-based system. The rule-based system may be designed to, for example, take ordinary training data (e.g., actual question and answer pairs where the answer is known to be correct) and modify it to make the question fit into one of the two above-described categories. This may include, for example, executing a rule that replaces a proper noun in a sentence with a fake word, and then generating an answer to that question in the form of “I cannot answer this question because I have no knowledge of <fake word>.” Likewise, this may also include, for example, executing a rule that replaces a common noun in a sentence with a different common noun, and then generating an answer to that question in the form of “I cannot answer this question because of missing information.”

This modified training data can then be included with the ordinary training data used to train the LLM. In this way, the LLM is trained to recognize when it does not have the correct answer and to indicate as such instead of hallucinating.

In another example embodiment, an LLM can be used to generate the training data, which is then used to train a separate LLM (or even the same LLM). For example, a system prompt may be generated as follows: Take the following logical puzzle but corrupt it, which means: Change the question so that no answer is possible anymore, for example because not enough context is provided. Provide information _why_ it cannot be answered.

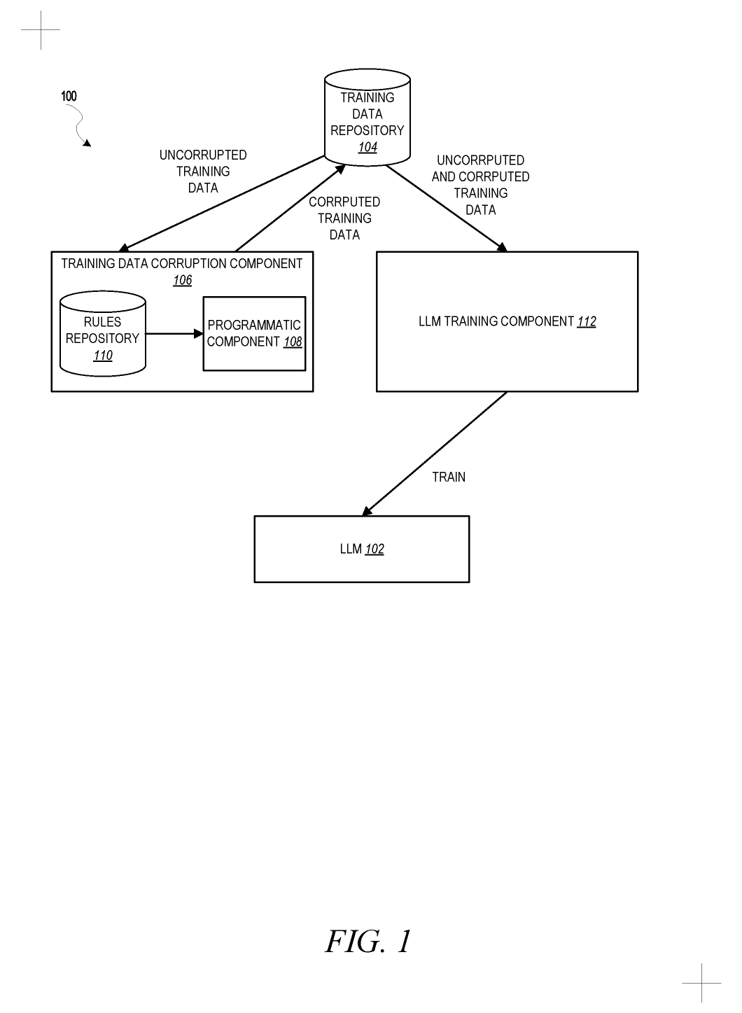

FIG. 1 is a block diagram illustrating a system 100 for training an LLM 102, in accordance with an example embodiment. Here, a corpus of training data is stored in a training data repository 104. A training data corruption component 106 extracts at least some of the training data from the training data repository 104 and intentionally corrupts it. In this example embodiment, the corruption is performed using a programmatic corruption component 108, which accesses a series of rules in a rules repository 110 and executes the rules so LLMs generate corrupted training data from the training data extracted from the training data repository 104. The corrupted training data is then stored back in the training data repository 104.

At some later time, an LLM training component 112 then extracts training data, including both corrupted and uncorrupted training data, from the training data repository 104, and uses the extracted training data to train the LLM 102.

It should be noted that the term “uncorrupted training data” as used throughout this disclosure shall be interpreted to mean any training data on which the corruption techniques described herein have not been performed. It is not intended to imply anything else about the state of this training data or how it may have been handled prior to potentially being corrupted using the techniques herein.

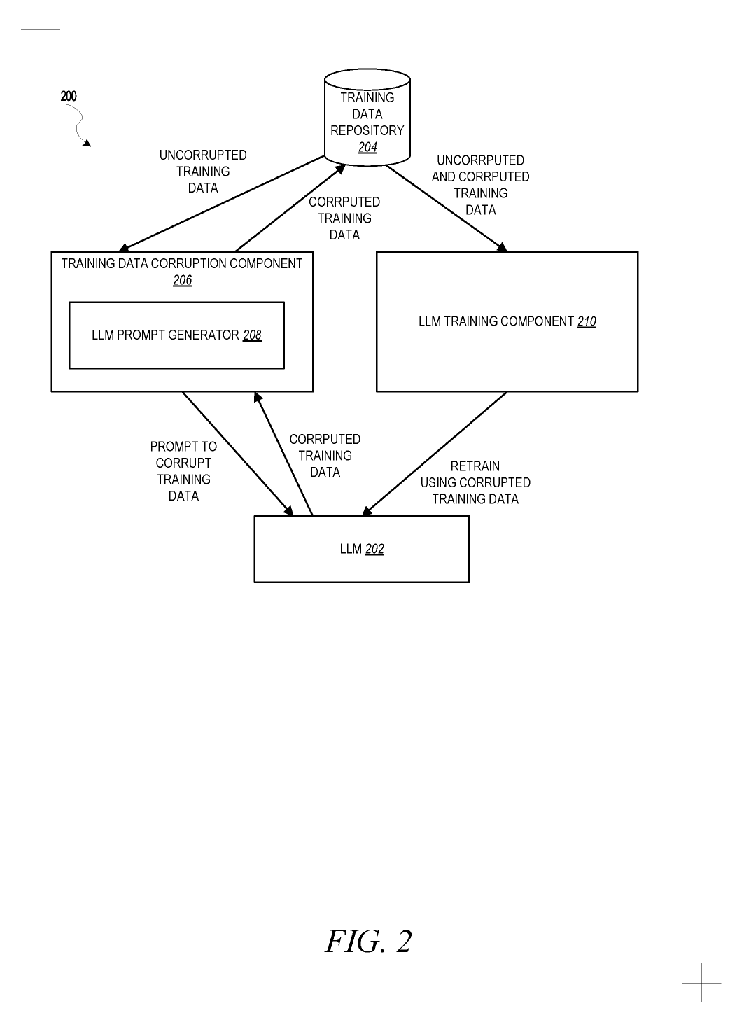

FIG. 2 is a block diagram illustrating a system 200 for training an LLM 202, in accordance with another example embodiment. Here, a corpus of training data is stored in a training data repository 204. A training data corruption component 206 extracts at least some of the training data from the training data repository 204 and intentionally corrupts it. In this example embodiment, the corruption is performed using an LLM prompt generator 208, which generates a prompt to the LLM 202 to corrupt the extracted training data. The corrupted training data is then stored back in the training data repository 204.

At some later time, an LLM training component 210 then extracts training data, including both corrupted and uncorrupted training data, from the training data repository 204, and uses the extracted training data to retrain the LLM 202.

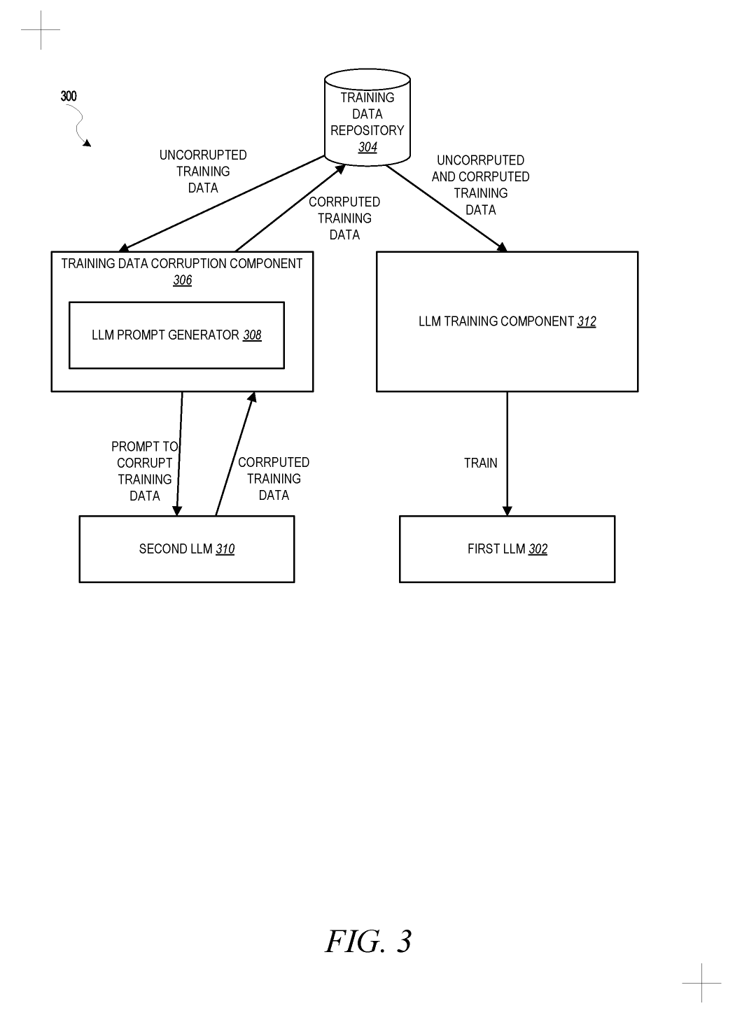

FIG. 3 is a block diagram illustrating a system 300 for training a first LLM 302, in accordance with another example embodiment. Here, a corpus of training data is stored in a training data repository 304. A training data corruption component 306 extracts at least some of the training data from the training data repository 304 and intentionally corrupts it. In this example embodiment, the corruption is performed using an LLM prompt generator 308, which generates a prompt to a second LLM 310 to corrupt the extracted training data. The corrupted training data is then stored back in the training data repository 304.

At some later time, an LLM training component 312 then extracts training data, including both corrupted and uncorrupted training data, from the training data repository 304, and uses the extracted training data to train the first LLM 302.

As to the LLMs themselves, LLMs used to generate information are generally referred to as Generative Artificial Intelligence (GAI) models. A GAI model may be implemented as a generative pretrained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model, known as a transformer, to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero sum game, according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and the discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational Auto-Encoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

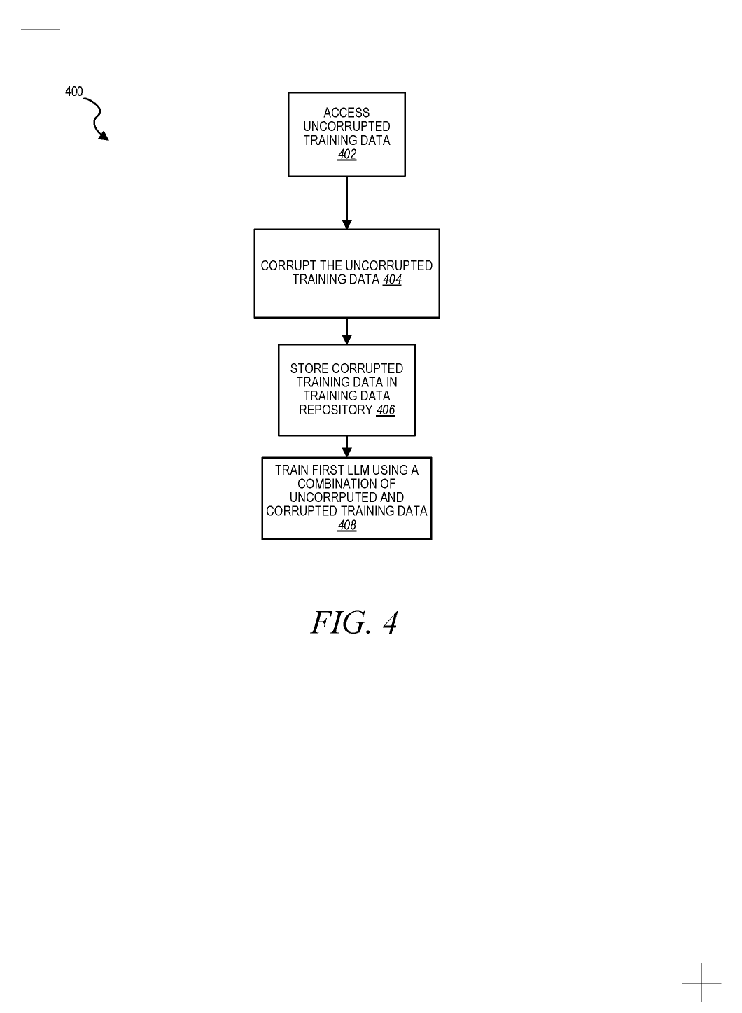

FIG. 4 is a flow diagram illustrating a method 400 for training a large language model (LLM), according to some examples, to reduce hallucinations in LLM outputs. Although the example method 400 depicted in FIG. 4 illustrates a particular sequence of operations, the sequence may be altered without departing from the scope of the present disclosure. For example, some of the operations depicted may be performed in parallel or in a different sequence that does not materially affect the function of the method 400. In some examples, different components of an example device or system that implements the method 400 may perform functions at substantially the same time or in a specific sequence.

At operation 402, uncorrupted training data for a first LLM is accessed. This data comprises a plurality of informational statements, each containing a first portion with contextual information and a second portion with information derivable from the context. The data is typically stored in a training data repository and accessed by a data retrieval component. In some examples, the data retrieval component may be a database management system that queries and retrieves the necessary data.

At operation 404, the method 400 proceeds to corrupt the uncorrupted training data. This involves altering the first portion of each informational statement and replacing the second portion with a statement indicating that an answer cannot be provided. A training data corruption component performs this operation, which may utilize a rules-based system or a second LLM to generate the corrupted data. In some examples, the rules-based system applies predefined rules to modify the data, such as replacing proper nouns with fictitious terms or altering contextual information.

At operation 406, the corrupted training data is stored back in the training data repository. This operation ensures that both corrupted and uncorrupted data are available for subsequent training processes. The storage operation may be managed by a data storage component, which organizes the data for efficient retrieval and use.

At operation 408, the method 400 involves training the first LLM using a combination of uncorrupted and corrupted training data. An LLM training component executes this operation, which involves feeding the data into the LLM and adjusting the model's parameters based on a loss function. The training component may employ optimization algorithms such as Adam or stochastic gradient descent to update the model's weights.

The decision-making process between operations involves determining the sequence of data corruption and storage operations. For instance, the method 400 may perform data corruption in parallel with data retrieval to optimize processing time. Additionally, the training component may alternate between batches of corrupted and uncorrupted data to enhance the model's learning process.

In some examples, the method 400 may include additional operations such as evaluating the model's performance on a validation set or fine-tuning the model for specific tasks. These operations may be performed by an evaluation component or a fine-tuning module, respectively.

In various embodiments, the system designed to reduce hallucinations in LLMs can be implemented with different configurations and operational methods. One embodiment involves a system where the hardware processor is a multiprocessing unit, allowing parallel processing of training data to enhance efficiency. The computer-readable medium could be a solid-state drive (SSD) for faster data access and retrieval. The uncorrupted training data may be stored in a distributed database system, enabling scalability and redundancy. In another embodiment, the corrupting process could utilize a neural network-based model instead of a rules-based component to dynamically alter informational statements, providing a more adaptive approach to data corruption. The system might also incorporate a feedback loop where the first LLM's performance is continuously monitored, and the training data is adjusted in real-time to further reduce hallucinations. Additionally, the system could be configured to operate in a cloud-based environment, allowing for remote access and integration with other AI systems. The GPT model used in the LLM could vary in size, from smaller models for resource-constrained environments to larger models for more complex applications. These embodiments demonstrate the system's adaptability and potential for integration into diverse technological ecosystems while maintaining the primary functionality of reducing hallucinations in LLMs.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: accessing uncorrupted training data for a first large language model (LLM), the uncorrupted training data comprising a plurality of informational statements, each informational statement comprising a first portion containing contextual information and a second portion containing information that can be derived using the contextual information; corrupting the uncorrupted training data by altering the first portion of each informational statement as well as replacing the second portion of each informational statement with a statement indicating that an answer cannot be provided; and training the first LLM using a combination of uncorrupted training data and the corrupted training data.

In Example 2, the subject matter of Example 1 comprises, wherein the corrupting comprises: generating a prompt instructing a second LLM to corrupt the uncorrupted training data; sending the prompt to the second LLM; and receiving, from the second LLM, the corrupted training data.

In Example 3, the subject matter of Example 2 comprises, wherein the prompt contains instructions to change the first portion of each informational statement so that it is not possible to answer a question using the first portion, and to change the second portion of each informational statement to an indication that an answer cannot be provided.

In Example 4, the subject matter of Examples 1–3 comprises, wherein the corrupting comprises using a rules-based component to automatically alter each informational statement based on a series of rules.

In Example 5, the subject matter of Examples 1–4 comprises, wherein the altering comprises, for each informational statement, either: replacing a proper noun in the first portion with a fake word; or replacing at least some of the contextual information with unrelated contextual information.

In Example 6, the subject matter of Examples 1–5 comprises, wherein the uncorrupted training data and the corrupted training data are stored in a training data repository.

In Example 7, the subject matter of Examples 1–6 comprises, wherein the LLM is a generative pretrained transformer (GPT) model.

Example 8 is a method comprising: accessing uncorrupted training data for a first large language model (LLM), the uncorrupted training data comprising a plurality of informational statements, each informational statement comprising a first portion containing contextual information and a second portion containing information that can be derived using the contextual information; corrupting the uncorrupted training data by altering the first portion of each informational statement as well as replacing the second portion of each informational statement with a statement indicating that an answer cannot be provided; and training the first LLM using a combination of uncorrupted training data and the corrupted training data.

In Example 9, the subject matter of Example 8 comprises, wherein the corrupting comprises: generating a prompt instructing a second LLM to corrupt the uncorrupted training data; sending the prompt to the second LLM; and receiving, from the second LLM, the corrupted training data.

In Example 10, the subject matter of Example 9 comprises, wherein the prompt contains instructions to change the first portion of each informational statement so that it is not possible to answer a question using the first portion, and to change the second portion of each informational statement to an indication that an answer cannot be provided.

In Example 11, the subject matter of Examples 8–10 comprises, wherein the corrupting comprises using a rules-based component to automatically alter each informational statement based on a series of rules.

In Example 12, the subject matter of Examples 8–11 comprises, wherein the altering comprises, for each informational statement, either: replacing a proper noun in the first portion with a fake word; or replacing at least some of the contextual information with unrelated contextual information.

In Example 13, the subject matter of Examples 8–12 comprises, wherein the uncorrupted training data and the corrupted training data are stored in a training data repository.

In Example 14, the subject matter of Examples 8–13 comprises, wherein the LLM is a generative pretrained transformer (GPT) model.

Example 15 is a non-transitory machine-readable medium storing instructions which, when executed by one or more processors, cause the one or more processors to perform operations comprising: accessing uncorrupted training data for a first large language model (LLM), the uncorrupted training data comprising a plurality of informational statements, each informational statement comprising a first portion containing contextual information and a second portion containing information that can be derived using the contextual information; corrupting the uncorrupted training data by altering the first portion of each informational statement as well as replacing the second portion of each informational statement with a statement indicating that an answer cannot be provided; and training the first LLM using a combination of uncorrupted training data and the corrupted training data.

In Example 16, the subject matter of Example 15 comprises, wherein the corrupting comprises: generating a prompt instructing a second LLM to corrupt the uncorrupted training data; sending the prompt to the second LLM; and receiving, from the second LLM, the corrupted training data.

In Example 17, the subject matter of Example 16 comprises, wherein the prompt contains instructions to change the first portion of each informational statement so that it is not possible to answer a question using the first portion, and to change the second portion of each informational statement to an indication that an answer cannot be provided.

In Example 18, the subject matter of Examples 15–17 comprises, wherein the corrupting comprises using a rules-based component to automatically alter each informational statement based on a series of rules.

In Example 19, the subject matter of Examples 15–18 comprises, wherein the altering comprises, for each informational statement, either: replacing a proper noun in the first portion with a fake word; or replacing at least some of the contextual information with unrelated contextual information.

In Example 20, the subject matter of Examples 15–19 comprises, wherein the uncorrupted training data and the corrupted training data are stored in a training data repository.

Example 21 is at least one machine-readable medium comprising instructions that, when executed by processing circuitry, cause the processing circuitry to perform operations to implement of any of Examples 1–20.

Example 22 is an apparatus comprising means to implement of any of Examples 1–20.

Example 23 is a system to implement of any of Examples 1–20.

Example 24 is a method to implement of any of Examples 1–20.

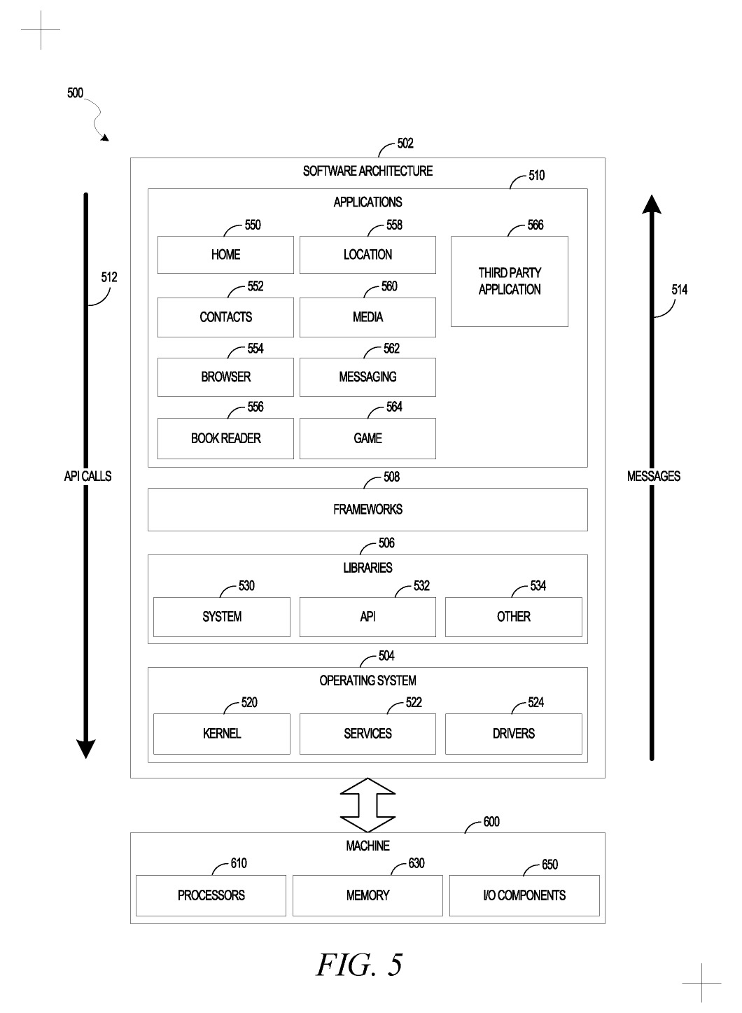

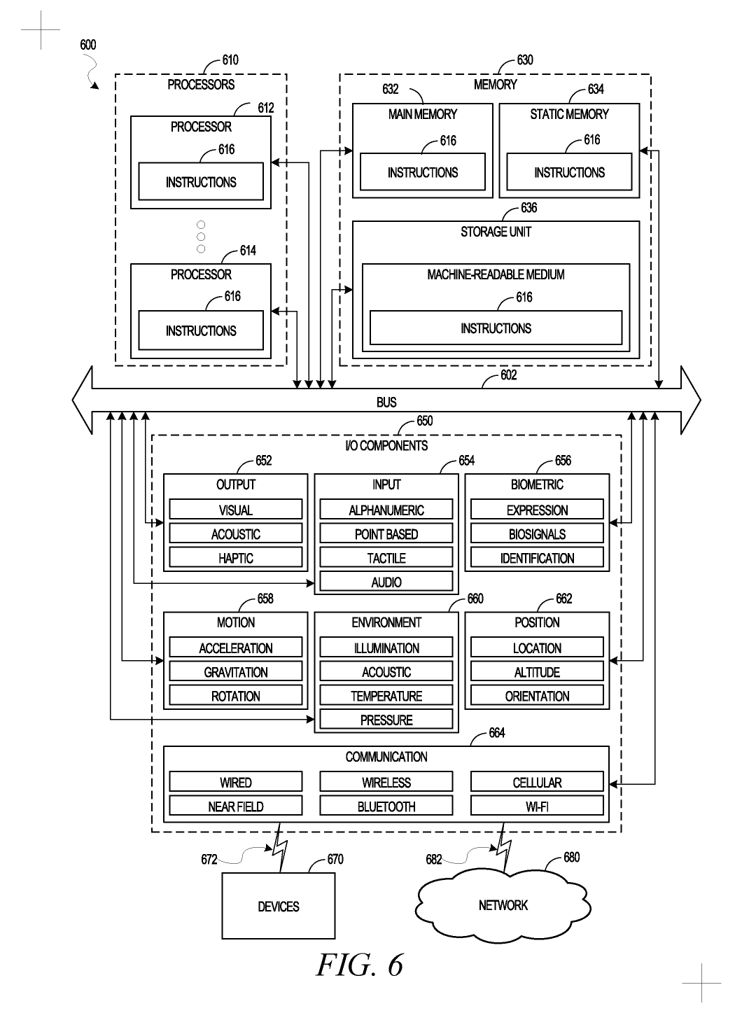

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that comprises processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionalities. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the method 400 of FIG. 4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may include a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor’s cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or include components operable to detect identifiers. For example, the communication components 664 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (e.g., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
accessing uncorrupted training data for a first large language model (LLM), the uncorrupted training data comprising a plurality of informational statements, each informational statement comprising a first portion containing contextual information and a second portion containing information that can be derived using the contextual information;
corrupting the uncorrupted training data by altering the first portion of each informational statement as well as replacing the second portion of each informational statement with a statement indicating that an answer cannot be provided; and
training the first LLM using a combination of uncorrupted training data and the corrupted training data.

2. The system of claim 1, wherein the corrupting comprises:
generating a prompt instructing a second LLM to corrupt the uncorrupted training data;
sending the prompt to the second LLM; and
receiving, from the second LLM, the corrupted training data.

3. The system of claim 2, wherein the prompt contains instructions to change the first portion of each informational statement so that it is not possible to answer a question using the first portion, and to change the second portion of each informational statement to an indication that an answer cannot be provided.

4. The system of claim 1, wherein the corrupting comprises using a rules-based component to automatically alter each informational statement based on a series of rules.

5. The system of claim 1, wherein the altering comprises, for each informational statement, either:
replacing a proper noun in the first portion with a fake word; or
replacing at least some of the contextual information with unrelated contextual information.

6. The system of claim 1, wherein the uncorrupted training data and the corrupted training data are stored in a training data repository.

7. The system of claim 1, wherein the LLM is a generative pretrained transformer (GPT) model.

8. A method comprising:
accessing uncorrupted training data for a first large language model (LLM), the uncorrupted training data comprising a plurality of informational statements, each informational statement comprising a first portion containing contextual information and a second portion containing information that can be derived using the contextual information;
corrupting the uncorrupted training data by altering the first portion of each informational statement as well as replacing the second portion of each informational statement with a statement indicating that an answer cannot be provided; and
training the first LLM using a combination of uncorrupted training data and the corrupted training data.

9. The method of claim 8, wherein the corrupting comprises:
generating a prompt instructing a second LLM to corrupt the uncorrupted training data;
sending the prompt to the second LLM; and
receiving, from the second LLM, the corrupted training data.

10. The method of claim 9, wherein the prompt contains instructions to change the first portion of each informational statement so that it is not possible to answer a question using the first portion, and to change the second portion of each informational statement to an indication that an answer cannot be provided.

11. The method of claim 8, wherein the corrupting comprises using a rules-based component to automatically alter each informational statement based on a series of rules.

12. The method of claim 8, wherein the altering comprises, for each informational statement, either:
replacing a proper noun in the first portion with a fake word; or
replacing at least some of the contextual information with unrelated contextual information.

13. The method of claim 8, wherein the uncorrupted training data and the corrupted training data are stored in a training data repository.

14. The method of claim 8, wherein the LLM is a generative pretrained transformer (GPT) model.

15. A non-transitory machine-readable medium storing instructions which, when executed by one or more processors, cause the one or more processors to perform operations comprising:
accessing uncorrupted training data for a first large language model (LLM), the uncorrupted training data comprising a plurality of informational statements, each informational statement comprising a first portion containing contextual information and a second portion containing information that can be derived using the contextual information;
corrupting the uncorrupted training data by altering the first portion of each informational statement as well as replacing the second portion of each informational statement with a statement indicating that an answer cannot be provided; and
training the first LLM using a combination of uncorrupted training data and the corrupted training data.

16. The non-transitory machine-readable medium of claim 15, wherein the corrupting comprises:
generating a prompt instructing a second LLM to corrupt the uncorrupted training data;
sending the prompt to the second LLM; and
receiving, from the second LLM, the corrupted training data.

17. The non-transitory machine-readable medium of claim 16, wherein the prompt contains instructions to change the first portion of each informational statement so that it is not possible to answer a question using the first portion, and to change the second portion of each informational statement to an indication that an answer cannot be provided.

18. The non-transitory machine-readable medium of claim 15, wherein the corrupting comprises using a rules-based component to automatically alter each informational statement based on a series of rules.

19. The non-transitory machine-readable medium of claim 15, wherein the altering comprises, for each informational statement, either:
replacing a proper noun in the first portion with a fake word; or
replacing at least some of the contextual information with unrelated contextual information.

20. The non-transitory machine-readable medium of claim 15, wherein the uncorrupted training data and the corrupted training data are stored in a training data repository.
